(19) United States
(12) Patent Application Publication
(10) Pub. No.: US 2025/0028299 A1
(43) Pub. Date: Jan. 23, 2025

(54) SYSTEM AND METHOD FOR VECTORIZED ADDITIVE MANUFACTURING

(71) Applicant: MATTHEWS INTERNATIONAL CORPORATION, Pittsburgh, PA (US)

(72) Inventor: Paul TUNIS, Sewickley, PA (US)

(21) Appl. No.: 18/779,547

(22) Filed: Jul. 22, 2024

Related U.S. Application Data
(60) Provisional application No. 63/528,238, filed on Jul. 21, 2023.
(60) Provisional application No. 63/553,753, filed on Feb. 15, 2024.

(51) Int. Cl. G05B 19/4099

(52) U.S. Cl. CPC G05B 19/4099; G05B 2219/49023

(57) ABSTRACT

Systems and methods for generating a customized product are described herein. The method includes receiving, by a processor, product design information for one or more products, wherein the product design information comprises customized information and template information; generating, by the processor, a vector image, for each of the one or more products, based on the customized information; generating, by the processor, slice data, for each of the one or more products, based on the vector image; receiving, by the processor, pre-sliced template data, for each of the one or more products, based on the template information; nesting, by the processor, the pre-sliced template data in a work area; and nesting, by the processor, the slice data in the work area to generate printing instructions.

### CROSS-REFERENCE TO RELATED APPLICATIONS

This application claims priority to U.S. Provisional Application No. 63/528,238 filed Jul. 21, 2023 and U.S. Provisional Application No. 63/553,753 filed Feb. 15, 2024. The entirety of each these applications is hereby incorporated by reference in their entireties.

### BACKGROUND

3D printing (also referred to as additive manufacturing) offers many advantages over conventional manufacturing techniques, especially in the foundry or metal casting industry. For example, complex parts and part geometries are often difficult or impossible to fabricate using conventional sand molding techniques. 3D printing is thus often used for rapid prototyping a single component within a more complex assembly or sand cores. The process enables mass production of a product and decreases production time compared to the use of traditional molds.

However, drawbacks exist when producing custom molds. For example, each custom mold requires the generation of a new 3D file. When performed manually, generating 3D models may be a time-intensive process that is prone to errors. Additionally, the initial data and artwork for the custom parts are not always well suited for translation into 3D modeling software. A further drawback is that quality assurance, in conventional workflows, is only performed after the casting has been performed. As such, the bulk of the expense of manufacturing the part has already been incurred before quality is assessed. These quality assurance systems also rely on external imaging systems, which may be costly. Accordingly, there exists a need for an automated process to generate printing instructions for additive manufacturing with a reduced computational overhead and increased quality assurance.

### SUMMARY

A method for generating a customized product may include receiving, by a processor, product design information for one or more products, wherein the product design information comprises customized information and template information; generating, by the processor, a vector image, for each of the one or more products, based on the customized information; generating, by the processor, slice data, for each of the one or more products, based on the vector image; receiving, by the processor, pre-sliced template data, for each of the one or more products, based on the template information; nesting, by the processor, the pre-sliced template data in a work area; and nesting, by the processor, the slice data in the work area to generate printing instructions.

In some embodiments, the method includes transmitting the printing instructions to an additive manufacturing device.

In some embodiments, the additive manufacturing device is a three-dimensional sand printer.

In some embodiments, the slice data and the pre-sliced template data correspond to portions of one or molds comprising a cavity configured cast the one or more products.

In some embodiments, the customized information comprises one or more characters of text and generating the slice data, for each of the one or more products, based on the vector image further includes simulating, by the processor, a draft on each of the one or more characters of text.

In some embodiments, the printing instructions are formatted in the Common Layer Interface.

In some embodiments, nesting the slice data in the work area further comprises performing, by the processor, affine transformations on one or more paths in the slice data.

In some embodiments, receiving the pre-sliced template data, for each of the one or more products, based on the template information, further includes generating, by the processor, a three-dimensional model of a template; slicing, by the processor, the three-dimensional model of the template into the pre-sliced template data; and storing, by the processor, the pre-sliced template data in a non-transitory storage medium.

In some embodiments, the method includes optimizing, by the processor, a utilization of the work area based on a combination of the slice data, the pre-sliced template data, and pre-sliced standard component data; and nesting, by the processor, the pre-sliced standard component data in the work area.

In some embodiments, generating the vector image, for each of the one or more products, based on the customized information further includes removing any intersecting curves in the vector image.

A system may include a processor and a non-transitory, processor-readable storage medium. The non-transitory, processor-readable storage medium may include one or more programming instructions that, when executed, cause the processor to receive product design information for one or more products, wherein the product design information comprises customized information and template information; generate a vector image, for each of the one or more products, based on the customized information; generate slice data, for each of the one or more products, based on the vector image; receive pre-sliced template data, for each of the one or more products, based on the template information; nest the pre-sliced template data in a work area; and nest the slice data in the work area to generate printing instructions.

In some embodiments, the system includes an additive manufacturing device, configured to generate the one or more products based on the printing instructions.

In some embodiments, the additive manufacturing device is a three-dimensional sand printer.

In some embodiments, the slice data and the pre-sliced template data correspond to portions of one or molds comprising a cavity configured to cast the one or more products.

In some embodiments, the customized information comprises one or more characters of text and the one or more programming instructions that cause the processor to generate the slice data, for each of the one or more products, based on the vector image further cause the processor to simulate a draft on each of the one or more characters of text.

In some embodiments, the printing instructions are formatted in the Common Layer Interface.

In some embodiments, the one or more programming instructions that cause the processor to nest the slice data in the work area further cause the processor to perform affine transformations on one or more paths in the slice data.

In some embodiments, the one or more programming instructions that cause the processor to receive the pre-sliced template data, for each of the one or more products, based on the template information, further cause the processor to generate a three-dimensional model of a template; slice the three-dimensional model of the template into the pre-sliced template data; and store the pre-sliced template data in the non-transitory storage medium.

In some embodiments, the one or more programming instructions further cause the processor to optimize a utilization of the work area based on a combination of the slice data, the pre-sliced template data, and pre-sliced standard component data and nest the pre-sliced standard component data in the work area.

A non-transitory computer-readable medium storing a set of executable instructions may include receiving product design information for one or more products, wherein the product design information comprises customized information and template information; generating a vector image, for each of the one or more products, based on the customized information; generating slice data, for each of the one or more products, based on the vector image; receiving pre-sliced template data, for each of the one or more products, based on the template information; nesting the pre-sliced template data in a work area; and nesting the slice data in the work area to generate printing instructions.

### BRIEF DESCRIPTION OF THE DRAWINGS

FIG. 1 depicts an illustrative manufacturing system in accordance with an embodiment.

FIG. 2 illustrates a flow diagram for creating a mold for casting a metal product in accordance with an embodiment.

FIG. 3A illustrates an example data file in a text format for artwork in accordance with an embodiment.

FIG. 3B illustrates a rendering of the data file in FIG. 3A in accordance with an embodiment.

FIG. 4A illustrates an example three-dimensional view of nested molds in accordance with an embodiment.

FIG. 4B illustrates a two-dimensional slice of the example of FIG. 4A generated for printing instructions.

FIG. 5A illustrates an example of generating slices from a 3D model in accordance with an embodiment.

FIG. 5B illustrates a visualization of the conversion of a 3D mesh model into 2D images in accordance with an embodiment.

FIG. 6 depicts the format of slice data contours in accordance with an embodiment.

FIG. 7 illustrates an example file in the common layer interface format in accordance with an embodiment.

FIG. 8 depicts an example vector graphic in accordance with an embodiment.

FIG. 9 illustrates an example visualization of additive manufacturing instructions in accordance with an embodiment.

FIG. 10 illustrates a traditional method for generating printing instructions for an additive manufacturing process.

FIG. 11 illustrates an improved method for generating printing instructions for an additive manufacturing process in accordance with an embodiment.

FIG. 12A illustrates an example vector file in accordance with an embodiment.

FIG. 12B illustrates a Bezier curve in accordance with an embodiment.

FIG. 13 illustrates a draft simulation for a character in accordance with an embodiment.

FIG. 14 illustrates a visualization of a nested slice featuring a plurality of molds in accordance with an embodiment.

FIG. 15 illustrates an example user interface for importing vector graphics and exporting printing instructions in accordance with an embodiment.

FIG. 16 illustrates a block diagram of a computing device for implementing the various methods and processes described herein in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

### DETAILED DESCRIPTION

This disclosure is not limited to the particular systems, devices and methods described, as these may vary. The terminology used in the description is for the purpose of describing the particular versions or embodiments only and is not intended to limit the scope.

The described technology generally relates to systems, methods, and computer program products for generating products via additive manufacturing. The methods may be specifically applied to the generation of molds and/or related tooling (“a metal casting mold” or “tooling”) for creating products through a casting process. In some embodiments, the casting molds may be created using an additive manufacturing technique. The methods and systems described herein may be used with various materials, including, without limitation, ferrous metals, non-ferrous metals, bronze, precious metals, aluminum, and/or combinations thereof, and/or the like. The methods and systems described herein may be used to create various products, including plaques, markers, memorials, signs, mechanical parts, and/or the like. A mold created according to some embodiments may be used in various casting processes, including, without limitation, sand casting, shell molding, permanent mold casting, investment casting, and die casting.

Some embodiments are directed to a method of generating a mold, the method comprising obtaining a product design through a digital input, manipulating the digital input to prepare a mold information, and making a mold from the mold information using an additive manufacturing process. In some embodiments, a method of making a cast product may comprise obtaining a product design through a digital input, manipulating the digital input to prepare the mold information, making a mold from the mold information using an additive manufacturing process, positioning the mold in a build area, forming a cast part or a cast product from the mold using a cast material; and, optionally, finishing the cast product per customer specifications. In some embodiments, one or more cast parts are needed for the cast product. In some embodiments, the digital input is manipulated/modified to optimize a mold design for the additive manufacturing process. In some embodiments, the digital input may be manipulated/modified to make a mold design by optimizing part size, dimensional depth, dimensional profile, profilometry (surface roughness/finish), strength, porosity, compaction, orientation, feature complexity, or the like. This manipulation and/or modification of the digital input may optimize the final product and/or processing characteristics across the scope of manufactured products. In some embodiments, the feature complexity may include typefaces or design aspects. In some embodiments, individual mold designs may be nested to optimize material use and production speed during the additive manufacturing process.

A variety of additive manufacturing technologies will be known to a person of skill in the art. Such technologies include, for example, binder jetting, directed energy deposition, material extrusion, material jetting, powder bed fusion, sheet lamination, and vat photopolymerization. These technologies may use a variety of materials for an additive manufacturing process, including various plastics and polymers, metals and metal alloys, ceramic materials, metal clays, organic materials, and the like. Any additive manufacturing technology and substrate suitable for the production of molds of embodiments herein and compatible with the molding of products, or compatible with the manufacturing of molds that may be subsequently used to mold products, is within the scope of the present disclosure. Likewise, other methods of additive manufacturing and associated materials, whether presently available or yet to be developed, are intended to be included within the scope of the present disclosure.

Systems can be assembled to aid in the generation of molds for casting a metal product. In some embodiments, the system comprises a processor, a manufacturing device operably connected to the processor, and a non-transitory, computer-readable medium storing instructions. The instructions, when executed, may cause the processor to automatically generate a mold for casting a metal product using product design information. In some embodiments, the instructions, when executed, may cause the processor to receive product design information of the metal product, preprocess the product design information to create a pre-processed file, create a mold design using the preprocessed file, and analyze the mold design to detect the presence or absence of defects. In some embodiments, the instructions, when executed, may further cause the processor to generate printing instructions for the mold design and nest the printing instructions in a work area. In some embodiments, the manufacturing device is configured to access the printing instructions from the processor and create the mold insert by an additive manufacturing process according to the printing instructions.

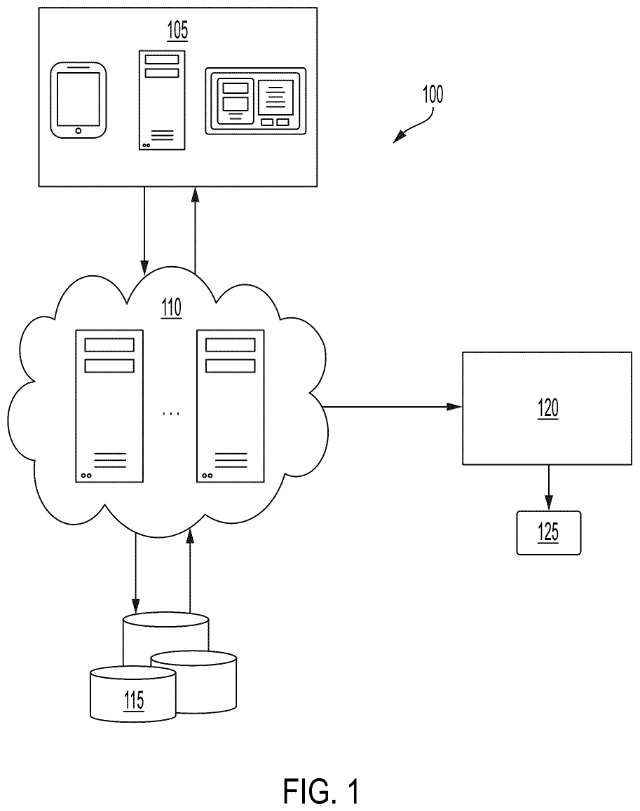

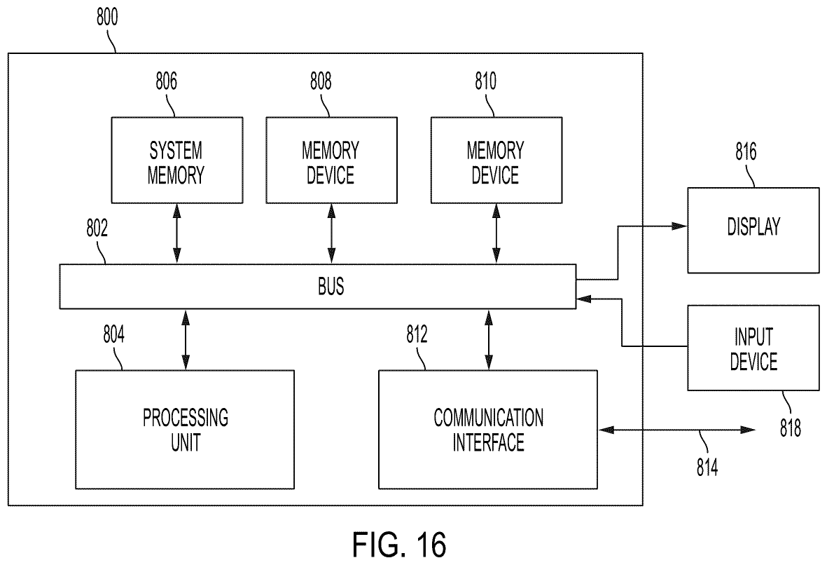

FIG. 1 depicts an illustrative manufacturing system according to an embodiment. As shown in FIG. 1, the manufacturing system 100 may include one or more system logic devices 110, which can generally include a processor, a non-transitory memory or other storage device for housing programming instructions, data or information regarding one or more applications, and other hardware, including, for example, the processing unit (CPU) 1604, system memory 1606, communication interface 1612, and/or memory devices 1608/1610 depicted in FIG. 16 and described below in reference thereto. In some embodiments, the system logic devices 110 can include server computing devices, workstation computing devices (personal computers or “PCs”), and/or the like. In some embodiments, the system logic devices 110 are part of a control system for a mold manufacturing device 120, such as an additive manufacturing device or three-dimensional printing device.

In some embodiments, the programming instructions may include a mold manufacturing application (the “manufacturing application”) configured to, among other things, design and/or generate a mold. The system logic devices 110 may be in operable communication with client logic devices 105, including, but not limited to, server computing devices, personal computers (PCs), kiosk computing devices, mobile computing devices, laptop computers, smartphones, tablet computing devices, cloud computing devices, or any other logic and/or computing devices now known or developed in the future.

In some embodiments, the manufacturing application may be accessible through various platforms, such as a client application, a web-based application, over the Internet, an e-commerce portal, and/or a mobile application (for example, a “mobile app” or “app”). According to some embodiments, the manufacturing application may be configured to operate on each client logic device 105 and/or to operate on a system logic device 110 accessible to client logic devices over a network, such as the Internet. All or some of the files, data and/or processes (for example, source information, data sets, or the like) used for accessing information may be stored locally on each client logic device 105 and/or stored in a central location and accessible over a network. In some embodiments, the processes may include a machine learning model.

In an embodiment, one or more data stores 115 may be accessible by the client logic devices 105 and/or the system logic devices 110. In some examples, the data stores 115 may include information sources having information used to design and/or generate a mold or customized portions of molds. For example, data stores 115 may include, without limitation, information from product catalogs, historical mold information, mold pattern information (e.g., mold templates, dimensions, cost information, and/or the like), e-commerce information, production information (e.g., a SKU number), material information, and/or the like. In some embodiments, the data stores 115 may include information obtained from multiple data sources, including third-party data sources.

Although the one or more data stores 115 are depicted as being separate from the logic devices 105, 110, embodiments are not so limited. All or some of the one or more data stores 115 may be stored in one or more of the logic devices 105, 110.

The system logic devices 110 may receive product specifications for a product. The product specifications may be analyzed by the manufacturing application to generate mold information. In some embodiments, the product specifications may be stored in the form of a digital file. The mold information may be transmitted to a manufacturing device 120, such as an additive manufacturing system. The manufacturing device 120 may generate a mold 125 based on the mold information. For example, the manufacturing application may generate, look up, or otherwise obtain information from the product specifications and translate this data into mold information that can be used by the manufacturing device 120 to generate the mold 125. The mold information can include a series of two-dimensional slices, that when processed in series (i.e., one on top of the other) by the manufacturing device 120 form the mold 125, or a plurality of molds. In some embodiments, the mold information may be stored in the form of a digital file (e.g., an *.stl file). The mold 125 may be used in various casting processes to generate a product, including, without limitation, sand casting, shell molding, permanent mold casting, investment casting, and die casting.

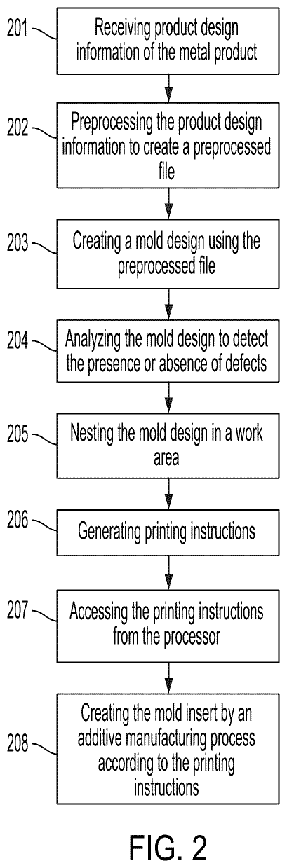

FIG. 2 illustrates a flow diagram of a method for creating a mold for casting a metal product. The method comprises receiving 201 product design information of the metal product, preprocessing 202 the product design information to create a pre-processed file, creating 203 a mold design using the preprocessed file, and analyzing 204 the mold design to detect the presence or absence of defects. In some embodiments, the method further comprises generating 205 printing instructions for the mold design and nesting 206 the printing instructions in a work area. In some embodiments, the method further comprises accessing 207 the printing instructions from the processor and creating 208 the mold insert by an additive manufacturing process according to the printing instructions.

In some embodiments, receiving 201 product design information associated with a metal product is performed by a processor. The mold manufacturing system may receive a product design that is to be manipulated and/or modified using scanning technologies and/or manual data manipulation to prepare files for use with additive manufacturing and other three-dimensional printing systems. The digital input may be in the form of engineering files, such as point cloud files, polygon mesh files, spline surface files, Boolean solid geometry files, or other related computer-aided design (CAD) files, raster/vector type files, and/or the like. In some embodiments, the manufacturing system uses stereolithography (*.stl) files for use with additive manufacturing systems.

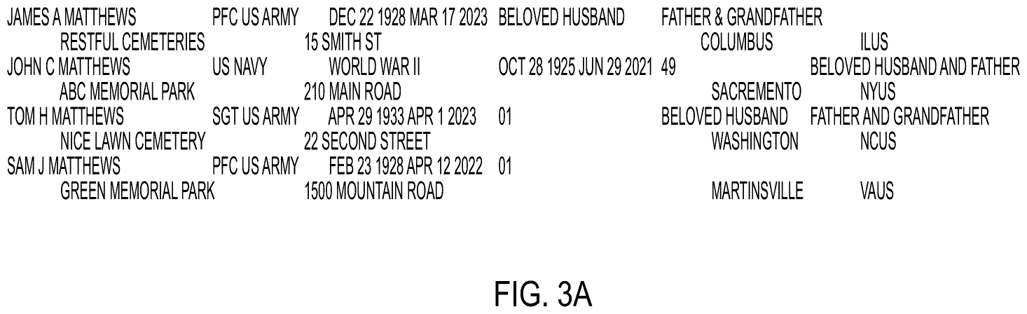

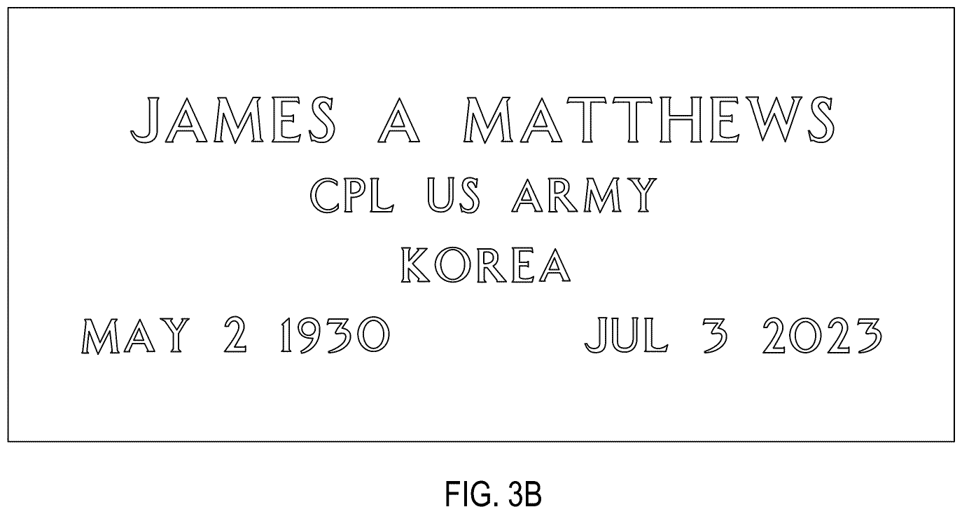

In certain embodiments, the digital input does not directly include a geometry of the mold. For example, the product design information may be provided in a text file, as illustrated in FIG. 3A. The product design information may be structured or unstructured.

In some embodiments, the product design information is preprocessed 202 by the processor. Processing 202 may include parsing the product design information and converting the file into an image and/or engineering file. The engineering file may be a two-dimensional drawing, such as in the encapsulated postscript (EPS) vector form, Portable Document Format (PDF), or Scalable Vector Graphics (SVG). For example, the product design information in FIG. 3A may be converted into a drawing similar to the one illustrated in FIG. 3B. In some embodiments, the product design information is structured based on one or more assumptions (e.g., product type characteristics). Product type characteristics may be associated with a class of products and/or an individual order. In some embodiments, product type characteristics include at least one of text layout, typeface, backing substrate shape, texture, depth of field, surface structure, material, and associated material properties (e.g., reflectance, color, gloss, anisotropy, scattering properties, etc.). For example, when creating a plaque, the product design information may explicitly define or reference a product type with various dimensions of the plaque (i.e., length, width and depth), standard ornamentations or decorations (e.g., specific borders, raised or lowered features, and other similar decorations), and other standard features. In some embodiments, one or more of these features may be provided using an interactive editing tool. The interactive editing tool may provide additional detail, such as text (e.g., a person's name, relevant dates, and other information related to the product being created), additional decorations (e.g., images), and any other elements that the design system is configured to support.

In some embodiments, the processor may create 203 the mold design using the digital input or a preprocessed file. The mold design may be procedurally generated. The mold design may be generated in any three-dimensional modeling software (e.g., Houdini). An example procedural network may include task operators for preprocessing two-dimensional vector information into a three-dimensional textured geometry, processing the three-dimensional textured geometry into a proper format (e.g., changing size and file type), rendering a reverse image of the mold for quality control, and reviewing the reverse image for quality control.

In some embodiments, the processor may analyze 204 the mold design to detect the presence or absence of defects. Based on the mold design, the processor may generate a three-dimensional mold geometry. In some embodiments, the three-dimensional mold geometry is rendered to a two-dimensional image. Rendering the geometry in two dimensions may lessen processing/memory requirements and simplify training for the machine learning algorithm.

In certain embodiments, the processor may classify the image or geometry with a machine learning algorithm. The machine learning algorithm may be supervised or unsupervised. Example machine learning algorithms for classification include convolutional neural networks, artificial neural networks, support vector machines, K-Means Clustering, and K-Nearest Neighbor algorithms. The machine learning algorithm may be trained to classify particular errors and/or intended structures (e.g., shapes, text, or figures) in a mold design. The machine learning algorithm may output a probability of an input including a particular error or an intended structure. Training sets may include labeled images or models. An image training set may include some combination of generated (e.g., rendered) imagery or photographs. For example, a training set may be generated with a set of images with known errors that are labeled accordingly. The training set may further include a set of images without errors that are labeled accordingly.

In some embodiments, the processor generates error flagging based on the classification. In embodiments where the output is a probability, an output from the machine learning algorithm may be compared against a threshold value to automatically determine whether to generate an error flag. Example errors that may be flagged include the vector not being recognized, which can result in a blank mold, visual detection of objects that are too close to one another, or visual detection of parts of the text and vectors that were not extruded properly or were produced in the wrong size. The text may also be extracted using text recognition and checked for spelling, letter sizes, etc. In some embodiments, potential mold issues that may cause flow problems are detected. In certain embodiments, errors flags are generated with different types and/or importance levels (e.g., warning or critical). In certain embodiments, multiple classifications can be weighted and combined to generate error flags.

In certain embodiments, in response to the detection of no errors of a certain type, the processor may automatically proceed with generating 205 printing instructions. In some embodiments, errors of certain types may require corrective action before generating 205 printing instructions. In response to some error flags, the processor may automatically modify the vector data. Alternatively, in response to some error flags, the processor may generate a recommendation for modifying the vector data. A user may either accept or deny the recommendation for automatic correction. Alternatively, a user may manually correct the error based on the recommendation.

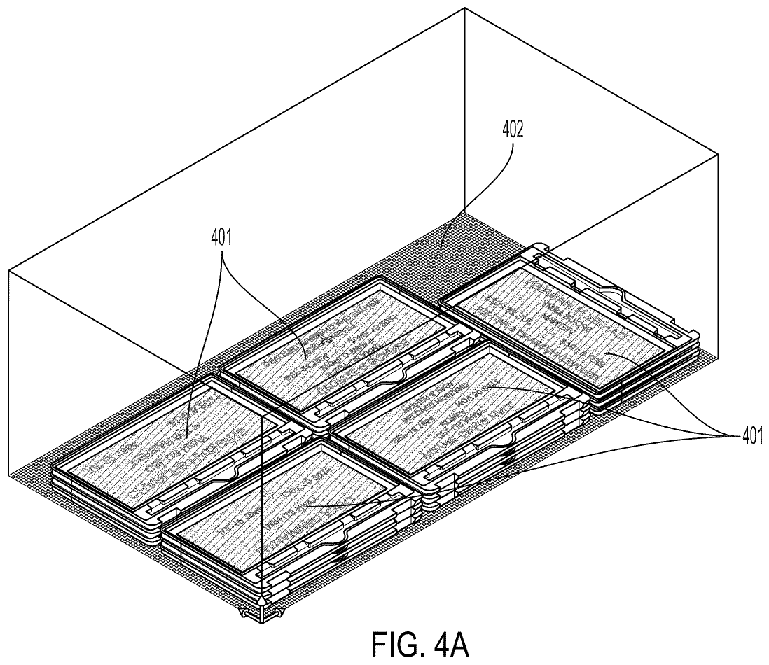

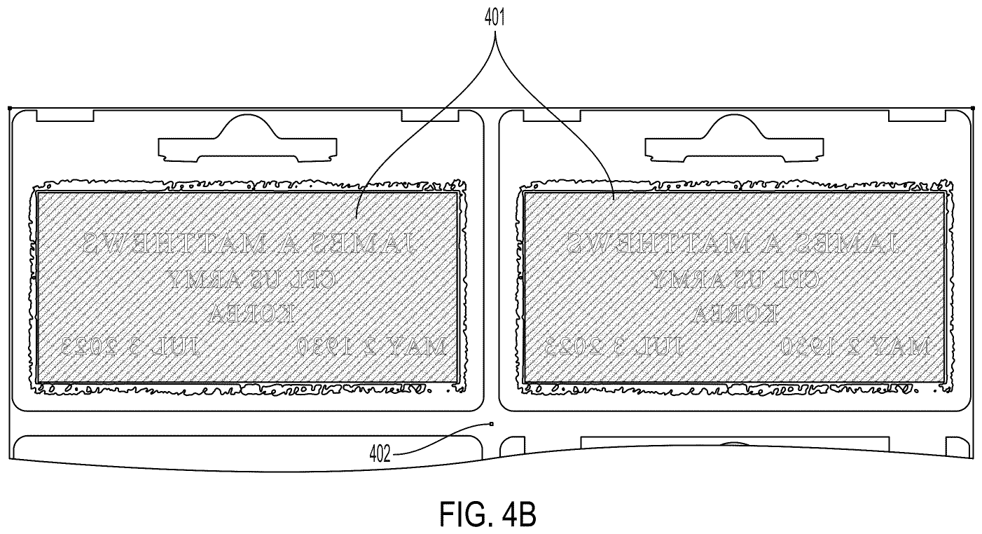

In some embodiments, the processor may nest 205 the printing instructions in the work area. Individual mold designs may be nested to optimize material use and production speed during the additive manufacturing process. FIG. 4A illustrates an example three-dimensional view of a plurality of nested molds 401 in accordance with an embodiment.

Although the example depicts nesting in two dimensions (e.g., horizontally), in some embodiments, the processor can nest individual mold designs in a third dimension (e.g., vertically). In further embodiments, nesting in the third dimension may be constrained based on a limited resolution of the additive manufacturing device in the third dimension as compared to the first and second dimensions.

In some embodiments, the processor may generate 206 printing instructions for the mold design(s). Typically, additive manufacturing devices (e.g., 3D printers) cannot identify a product's or mold's geometry directly from a three-dimensional mesh file (e.g., STL or OBJ). Rather, an additive manufacturing device reads layers of data that are sliced from a three-dimensional geometry. Additive manufacturing devices may use a CLI (common layer interface) file, which is a set of two-dimensional slices that are stacked in the z direction and allow additive manufacturing devices to generate three-dimensional parts in a work area. In certain embodiments, slicing is done in Netfabb (i.e., an Autodesk program) using the Lua scripting language. Individual or nested mold designs may be sliced into layers for generating 206 printing instructions. FIG. 4B illustrates a two-dimensional slice of the nested example of FIG. 4A. An example additive manufacturing device may be configured to produce a mold based on a plurality of two-dimensional slices. Each slice may signify where, and where not, to apply a binding agent during the additive manufacturing process. Distinct mold components 401 may be separated by areas 402 in which the binding agent will not be applied.

In some embodiments, the printing instructions are accessed 207 by a manufacturing device. The mold may be created 208 by an additive manufacturing process in the manufacturing device.

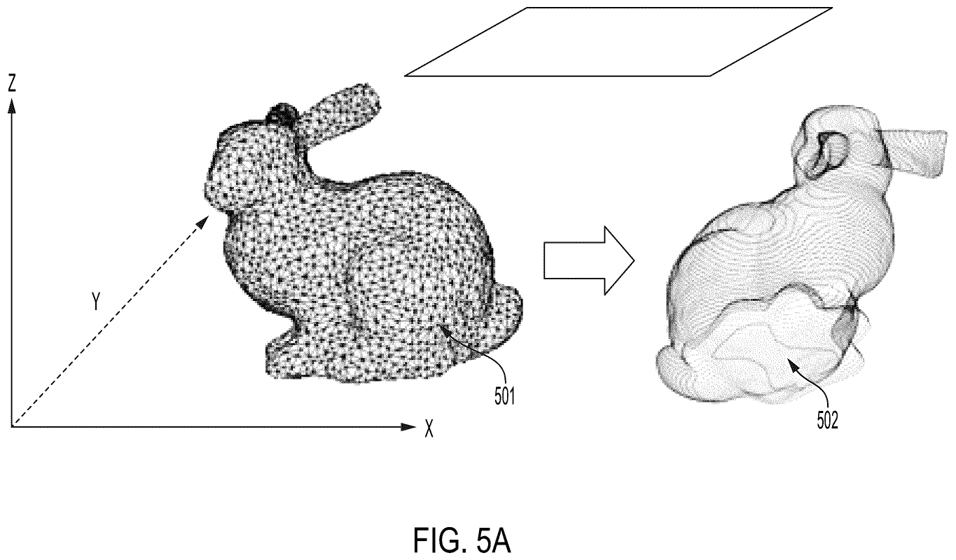

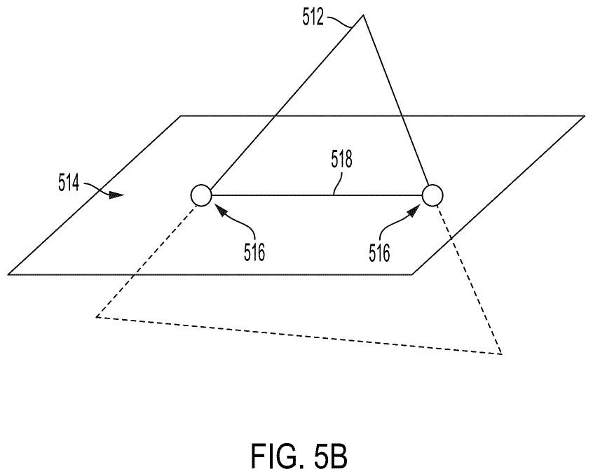

FIG. 5A illustrates an illustration of how slices are generated from a 3D model in accordance with an embodiment. As disclosed herein, additive manufacturing devices, such as 3D sand printers, produce a 3D object by printing stacks of 2D images 502 (i.e., in an X and Y direction) on top of one another (i.e., in a Z direction). Printing may be performed by directly applying the printing material or by applying a binder in one or more designated portions of the 2D images to a particulate (e.g., sand). The 2D images 502 or contours may be generated from 3D models 501. The 3D models 501 may represent a single object or a plurality of objects. The 2D images 502 may be produced at a predetermined step (i.e., a resolution) along the Z axis.

Generating the 2D images 502 may include converting a 3D model 501 to a mesh (e.g., an STL). FIG. 5B illustrates a visualization of the conversion of a 3D mesh model into 2D images in accordance with an embodiment. For each predetermined step, a plane 514 is placed in intersection with the mesh model. The intersection locations 516 where the plane 514 contacts a triangle 512 of the mesh may be calculated by mathematically exact methods or interpolation.

The segment 518 formed by the intersections 516 may be determined. The segments for all triangles intersecting the plane 514 may be joined to create a closed loop, which forms the contour or polyline.

Generating the 2D images 502 is traditionally computationally intensive and requires substantial processing power and expensive software. The computational intensity may further result in long lead times. Additionally, the mesh files generated during processing may be very large and therefore, require extensive storage infrastructure.

In some embodiments, the 2D images or slice data is formatted in the Common Layer Interface (CLI). These files may be stored in either ASCII or Binary format and contain contour data at various slice heights (i.e., along the Z axis).

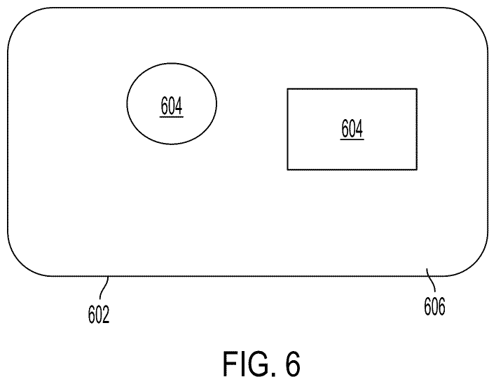

FIG. 6 depicts the format of the slice data contours in accordance with an embodiment. The winding direction of the contours may be important for differentiating internal 604 and external 602 contours. Determining a winding direction may include calculating a normal (i.e., perpendicular to the face) for each triangle in the 3D mesh. A cross product may be calculated from the intersecting line segment vector 518 and the triangle normal to determine a winding direction. The contour data may be rasterized to build a bitmap image from the contours and thereby identify a solid portion 606 (i.e., where binder will be applied).

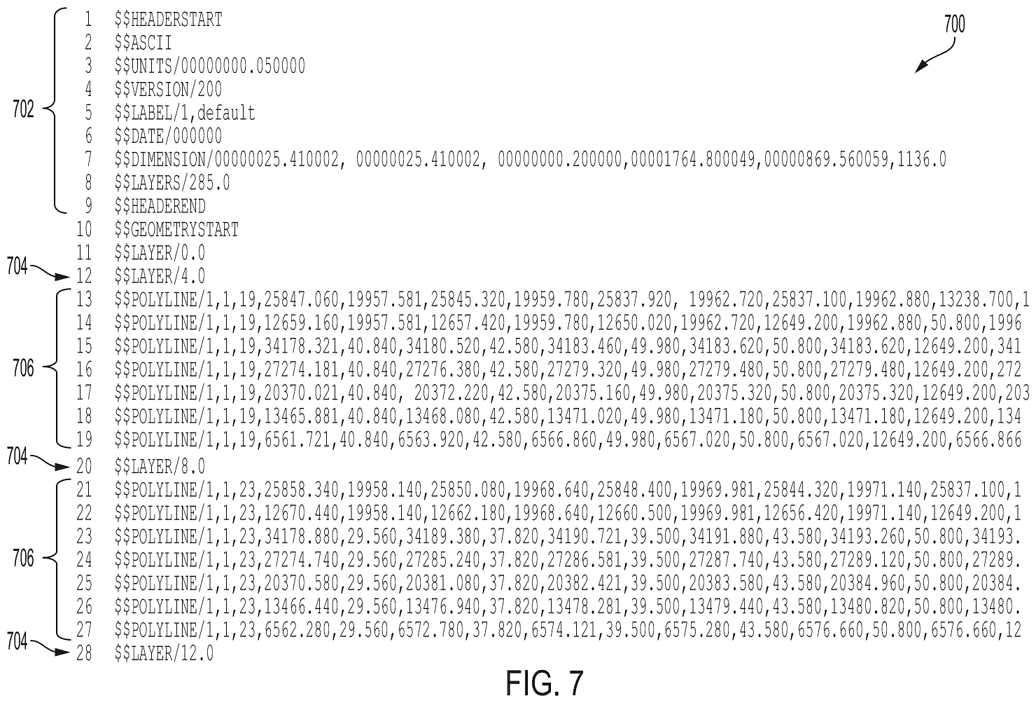

FIG. 7 illustrates an example file 700 in the common layer interface format in accordance with an embodiment. As shown in the example depicted in FIG. 7, the CLI file 700 may be written in ASCII. Alternatively, the CLI file 700 may be written in binary. Varying formats of the CLI file 700 may include trade-offs of particular computational and/or storage requirements associated with the file 700.

The CLI file 700 may include a header 702 that outlines the format (e.g., ASCII vs binary), unit scale, dimensions, and number of layers. The header 702 may further include identifying information associated with the CLI file 700 (e.g., a label identifier, a version, a creation/update date, etc.).

The CLI file 700 may include a layer identifier 704 and polyline data 706 for each layer. The layer identifier 704 may be based on the slice height. The polyline data 706 may define the contours of the layer. In the example, the second numerical value in each line of the polyline data 706 defines the winding direction (e.g., as either 1 or 0). The third numerical value is the number of points within the closed loop polyline. The remaining values identify a set of X and Y coordinates for each point in the polyline. The first and last points may duplicate the same value to form a closed loop.

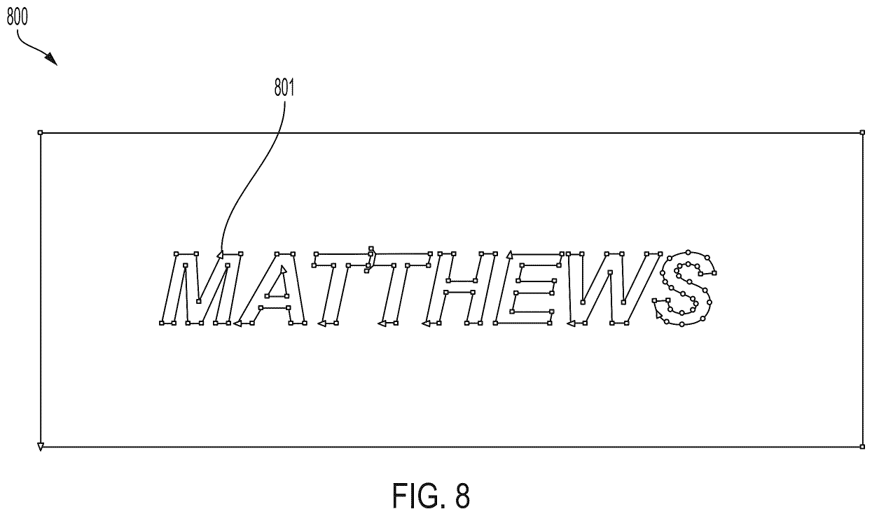

FIG. 8 depicts an example vector graphic 800 in accordance with an embodiment. Vector graphics are widely used in the signage, graphical design, and marketing industries. Vector graphics are lightweight compared to a rasterized image and can be easily scaled up and down without any loss of resolution. The points 801 in the example vector graphic 800 are shown above with markers. Similar to the CLI format, the winding direction of the points 801 may be important for determining where “fills” are applied (i.e., determining the inside of the characters versus the background).

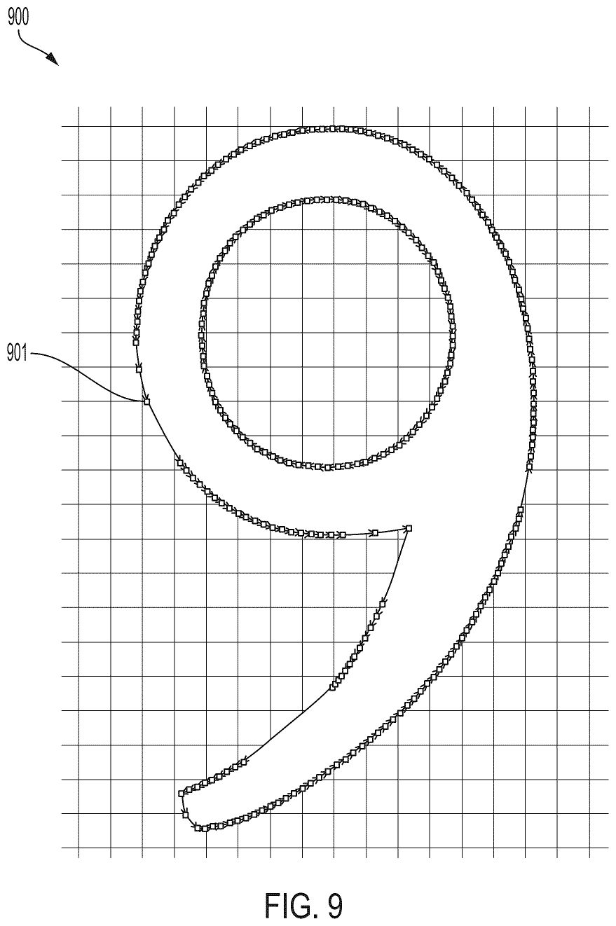

FIG. 9 illustrates a visualization 900 of an example CLI file in accordance with an embodiment. The visualization 900 depicts the contour points 901 and winding direction in X-Y space. As illustrated, the vector graphic 800 and visualization 900 of a CLI file each contain vectors (e.g., either lines or curves) and are formed by points and equations in X and Y space.

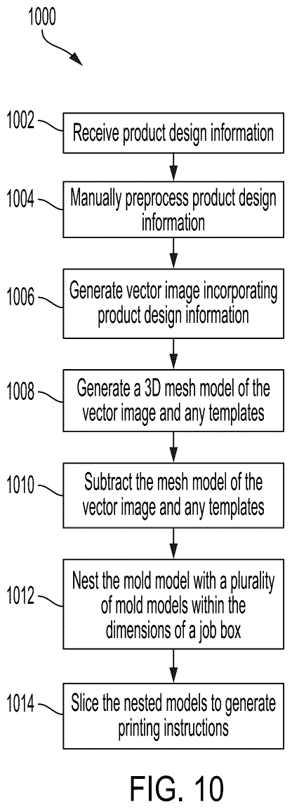

FIG. 10 illustrates a traditional method 1000 for generating printing instructions for an additive manufacturing process. The method 1000 may include receiving 1002 product design information (e.g., as described above in reference to FIG. 3A).

The method 1000 may including manually preprocessing 1004 the product design information (i.e., preprocessing). In some embodiments, the product design information may include artwork. Each artwork may be preprocessed 1004 in image processing software (e.g., Corel Draw) to check the product design information for potential issues. For example, overlapping curves and objects may need to be removed or corrected manually. A vector image (e.g., PDF, EPS, etc.) may be generated 1006 incorporating the product design information. A vector image is defined by points, lines, and curves that are based upon mathematical equations (as opposed to defined pixels).

The method 1000 may include generating 1008 a three-dimensional mesh model of the vector image. The vector artwork may be modified in modeling software to create the model. The artwork may be integrated with a loaded template. Additional elements from the product design information may additionally be incorporated (e.g., letters, emblems, features, etc.). The model may be exported as a mesh (e.g., a triangle mesh).

The method 1000 may include subtracting 1010 the mesh model from a solid mold to generate a mold model (i.e., inverting the mesh into a mold cavity). Subtracting 1010 the mesh model may be performed using a Boolean algorithm to create a mold cavity.

The method 1000 may include nesting 1012 the mold model with a plurality of mold models within the dimensions of a job box. Nesting 1012 may include manually rotating and/or translating the mold model and the plurality of mold models to properly fit them all in the job box dimensions.

The method 1000 may include slicing 1014, using a slicing algorithm, the nested models within the job box dimensions to generate slice data. The slice data may be exported as printing instructions (e.g., in the CLI format). As described above, slicing the model data for an entire job box may be a computing-intensive, and therefore time-intensive, process.

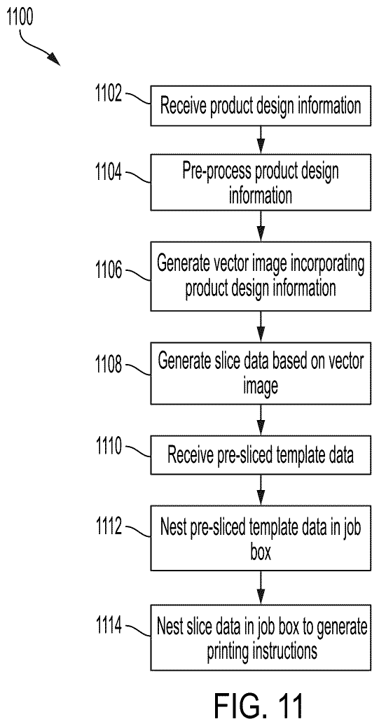

FIG. 11 illustrates an improved method 1100 for generating printing instructions for an additive manufacturing process in accordance with an embodiment. The method 1100 may include receiving 1102 product design information (e.g., as described above in reference to FIG. 3A).

In certain embodiments, the method 1100 includes preprocessing 1104 any artwork in the product design information. The artwork may be received or converted into a vector format. In some embodiments, preprocessing 1104 includes removing any intersecting curves, converting embedded text to vectors, and/or checking for errors. The preprocessing may be performed by the system logic devices 110. Alternatively, the system logic devices 110 may detect at least one of an intersecting curve or other error and alert a user.

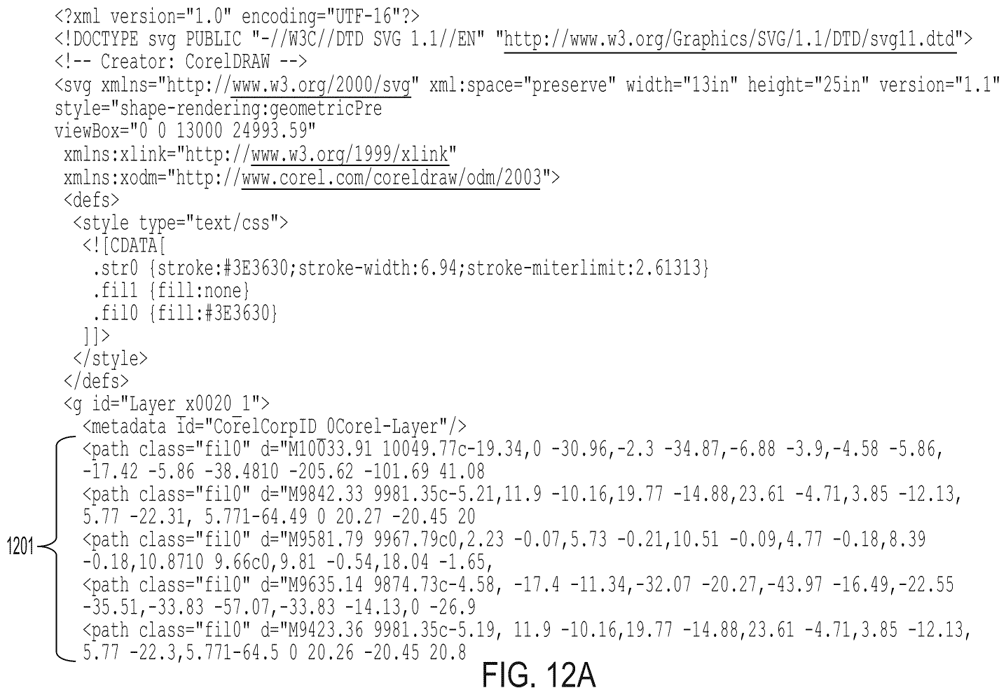

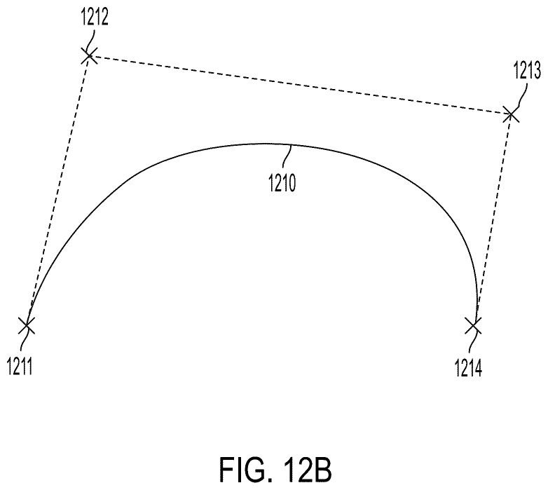

A vector image (e.g., an SVG) may be generated 1106 based on the preprocessed product design information. SVG is widely used in many industries because it is a lightweight image format based on XML. Using SVG allows a user to easily open the file and view the vector data directly without any encoding. FIG. 12A illustrates an example vector file in accordance with an embodiment. In the example file, lines are coded as paths or polygons. Polygons may be collections of points in a plane that can be easily converted to a format for printing (e.g., CLI). Paths may be defined by a combination of points and curves. The curves may include Bezier curves. FIG. 12B illustrates a Bezier curve 1210 in accordance with an embodiment. The curves 1210 are defined by a start point 1211, an end point 1214, and one or more control points, such as 1212 and 1213. In some embodiments, the control points 1212/1213 may not lie on the curve 1210. Instead, the control points 1212/1213 may define a function for describing the curve 1210. As with all vector graphics, Bezier curves maintain resolution when scaled. Furthermore, affine transformations (e.g., translations and rotations) may be applied to the curve by applying a respective transform to the start point 1211, end point 1214, and/or control points 1212/1213 of the curve 1210.

The method 1100 may include generating 1108 slice data based on the vector image.

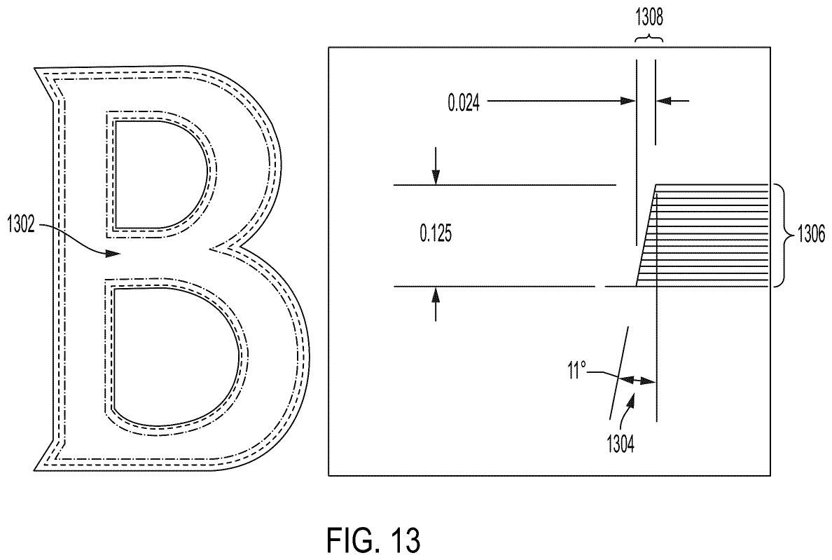

If the vector image incorporates text, a draft on the characters may be simulated across a plurality of slices. With traditional molding, a draft was added to allow for better pattern release from the mold. While the molding techniques described herein (e.g., molds produced via additive manufacturing) do not require a draft, the aesthetics of a draft on text may enhance visualization of the product. FIG. 13 illustrates a draft simulation for a character 1302 in accordance with an embodiment.

To simulate a draft, the outline of each character 1302 is expanded or reduced, according to a draft angle 1304, along the depth 1306 of the character 1302. A vector graphic generating tool may automatically generate the draft across a series of slices based on a height of the character 1302 and the degree of draft 1304. The vector graphic generating tool may determine a total differential 1308 across the character 1302. A differential for each layer may be determined based on the total differential 1308 and the resolution (i.e., layer depth) of the additive manufacturing device.

In certain embodiments, the method 1100 includes receiving 1110 pre-sliced template data. The pre-sliced template data may be generated in a similar manner as the previously discussed generated 1108 slice data. Because the template may be consistent between custom products, the computationally intensive slicing process may be performed once, and the output may be reused for the generation of multiple custom molds.

In some embodiments, the method 1100 includes nesting 1112 the pre-sliced template data in a predefined space. The predefined space may be based on the dimensions of a job box for an additive manufacturing device.

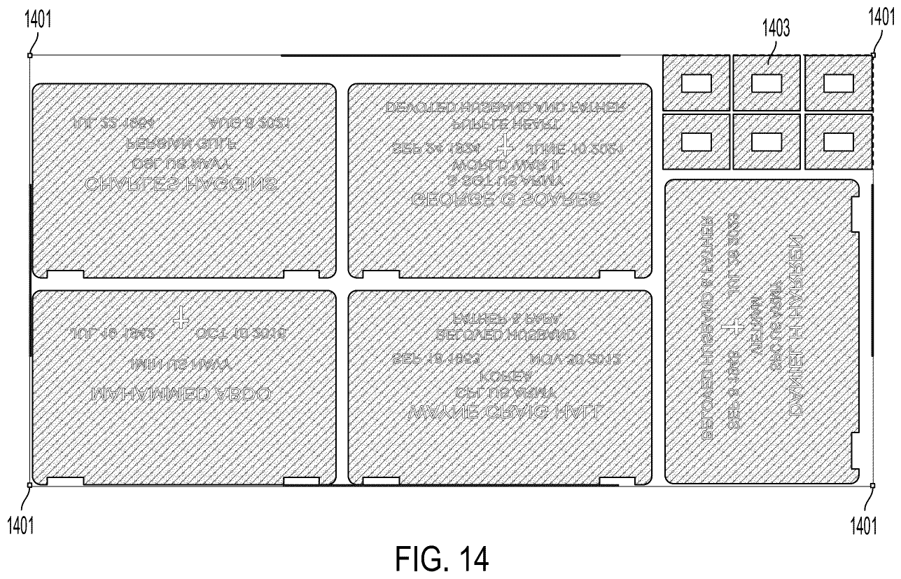

The method 1100 may include nesting 1114 the slice data with the pre-sliced template data in the predefined space. FIG. 14 illustrates a visualization of a nested slice featuring a plurality of molds in accordance with an embodiment.

In some embodiments, the slice data may be integrated entirely within the dimensions of the pre-sliced data. For example, nesting 1114 the slice data associated with the customization of a plaque typically does not exceed the dimensions of the template for a plaque mold. In other embodiments, where the slice data does alter the outer dimensions of the printed product, nesting may first be performed on an estimate or pre-determined threshold dimensionality for printed product. Alternatively, the printed product may be modeled to determine a precise dimensionality.

In some embodiments, nesting may be optimized using a bin packing algorithm (e.g., best-fit, first-fit, refined first-fit, harmonic-k, etc.). In certain embodiments, nesting may be optimized using a next-fit (e.g., next-fit, next-k-fit, next-fit-decreasing) pin backing algorithm.

A software tool may read a batch of vector graphic files (e.g., SVGs) and layer in the data (e.g., text and emblems) to create the necessary letter height. Vector graphics from multiple sources (e.g., based on product design information and templates) may be converted into printing instructions (e.g., CLI) and merged using non-computationally intensive two-dimensional math. Parts may be rotated and translated, for nesting, using similar non-computationally intensive two-dimensional math.

Other standard components 1403 (e.g., pour cups or cores) may be pre-sliced, similarly to templates, and added automatically to fill dead space in the box (i.e., defined by point 1401) to increase box utilization.

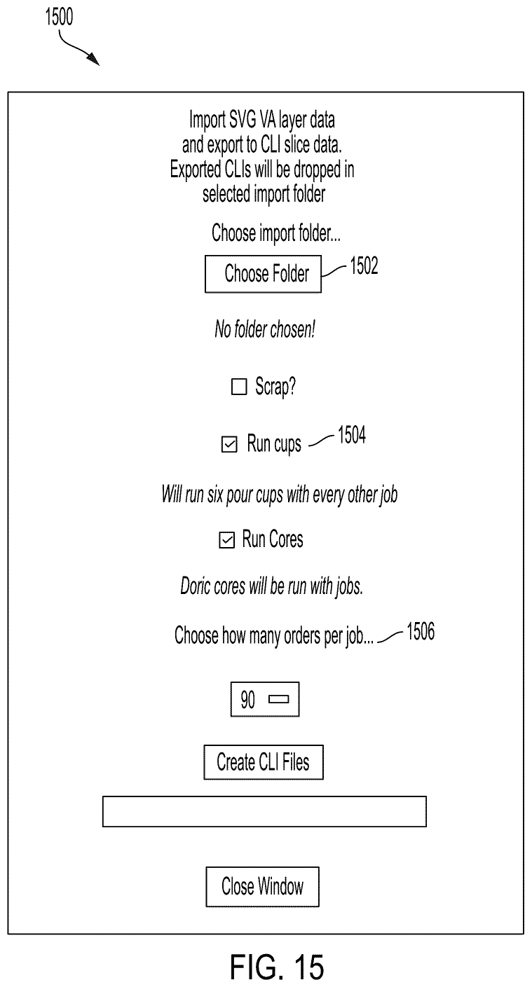

FIG. 15 illustrates an example user interface 1500 for importing vector graphics and exporting printing instructions in accordance with an embodiment. The user interface 1500 may include an option to import 1502 slice data for processing. The slice data may be a set of vector graphics (e.g., SVGs). The user interface 1500 may include one or more options 1504 to increase box utilization as described herein. The options 1504 may allow a user to select one or more standard components to fill empty spaces in the job box. In some embodiments, selecting an option automatically adds a pre-determined quantity of the standard component into the job box. In other embodiments, selecting an option 1504 optimizes box utilization by nesting the standard component (or a plurality of standard components) to best fit the job box. In other embodiments, selecting the option 1504 may automatically cycle between a variety of commonly needed standard components (e.g., weighted based on how often they are needed).

In certain embodiments, the user interface 1500 allows the user to customize 1506 the quantity of various orders to process per job box and/or produce multiple copies of an order, potentially across multiple job boxes.

An example system utilizing vector conversion (e.g., see FIG. 11) may have multiple benefits over a system following traditional methods (e.g., see FIG. 10) for generating printing instructions. An average run time may be reduced from days to hours by removing the repetitive conversion of templates. By removing extraneous 3D modeling and manipulations thereof, computing requirements may be significantly reduced (i.e., from expensive dedicated computers to standard off-the-shelf hardware). In addition, storage requirements for the resulting files may be reduced by an order of magnitude for similar reasons.

### Example Data Processing System

FIG. 16 is a schematic block diagram illustrating an example system 1600 of hardware components capable of implementing examples of the systems and methods disclosed herein. The system 1600 can include various systems and subsystems. The system 1600 can include one or more of a personal computer, a laptop computer, a mobile computing device, a workstation, a computer system, an appliance, an application-specific integrated circuit (ASIC), a server, a server BladeCenter, a server farm, etc.

The system 1600 can include a system bus 1602, a processing unit 1604, a system memory 1606, memory devices 1608 and 1610, a communication interface 1612 (e.g., a network interface), a communication link 1614, a display 1616 (e.g., a video screen), and an input device 1618 (e.g., a keyboard, touch screen, and/or a mouse). The system bus 1602 can be in communication with the processing unit 1604 and the system memory 1606. The additional memory devices 1608 and 1610, such as a hard disk drive, server, standalone database, or other non-volatile memory, can also be in communication with the system bus 1602. The system bus 1602 interconnects the processing unit 1604, the memory devices 808 and 1610, the communication interface 1612, the display 1616, and the input device 1618. In some examples, the system bus 1602 also interconnects an additional port (not shown), such as a universal serial bus (USB) port.

The processing unit 1604 can be a computing device and can include an application-specific integrated circuit (ASIC). The processing unit 1604 executes a set of instructions to implement the operations of examples disclosed herein. The processing unit can include a processing core.

The additional memory devices 1606, 1608, and 1610 can store data, programs, instructions, database queries in text or compiled form, and any other information that may be needed to operate a computer. The memories 1606, 1608 and 1610 can be implemented as computer-readable media (integrated or removable), such as a memory card, disk drive, compact disk (CD), or server accessible over a network. In certain examples, the memories 1606, 1608 and 1610 can comprise text, images, video, and/or audio, portions of which can be available in formats comprehensible to human beings.

Additionally, or alternatively, the system 1600 can access an external data source or query source through the communication interface 1612, which can communicate with the system bus 1602 and the communication link 1614.

In operation, the system 1600 can be used to implement one or more parts of a system in accordance with the present invention, such as system 100. Computer executable logic for implementing the diagnostic system resides on one or more of the system memory 1606 and the memory devices 1608 and 1610 in accordance with certain examples. The processing unit 1604 executes one or more computer executable instructions originating from the system memory 1606 and the memory devices 1608 and 1610. The term “computer readable medium” as used herein refers to a medium that participates in providing instructions to the processing unit 1604 for execution. This medium may be distributed across multiple discrete assemblies all operatively connected to a common processor or set of related processors.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the embodiments described above.

What is claimed is:

1. A method for generating a customized product, the method comprising:
receiving, by a processor, product design information for one or more products, wherein the product design information comprises customized information and template information;
generating, by the processor, a vector image, for each of the one or more products, based on the customized information;
generating, by the processor, slice data, for each of the one or more products, based on the vector image;
receiving, by the processor, pre-sliced template data, for each of the one or more products, based on the template information;
nesting, by the processor, the pre-sliced template data in a work area; and
nesting, by the processor, the slice data in the work area to generate printing instructions.

2. The method of claim 1, further comprising transmitting the printing instructions to an additive manufacturing device.

3. The method of claim 2, wherein the additive manufacturing device is a three-dimensional sand printer.

4. The method of claim 1, wherein the slice data and the pre-sliced template data correspond to portions of one or molds comprising a cavity configured to cast the one or more products.

5. The method of claim 1, wherein the customized information comprises one or more characters of text; and
wherein generating the slice data, for each of the one or more products, based on the vector image further comprises simulating, by the processor, a draft on each of the one or more characters of text.

6. The method of claim 1, wherein the printing instructions are formatted in the Common Layer Interface.

7. The method of claim 1, wherein nesting the slice data in the work area further comprises performing, by the processor, affine transformations on one or more paths in the slice data.

8. The method of claim 1, wherein receiving the pre-sliced template data, for each of the one or more products, based on the template information, further comprises:
generating, by the processor, a three-dimensional model of a template;
slicing, by the processor, the three-dimensional model of the template into the pre-sliced template data; and
storing, by the processor, the pre-sliced template data in a non-transitory storage medium.

9. The method of claim 1, further comprising:
optimizing, by the processor, a utilization of the work area based on a combination of the slice data, the pre-sliced template data, and pre-sliced standard component data; and
nesting, by the processor, the pre-sliced standard component data in the work area.

10. The method of claim 1, wherein generating the vector image, for each of the one or more products, based on the customized information further comprises removing any intersecting curves in the vector image.

11. A system comprising:
a processor; and
a non-transitory, processor-readable storage medium, wherein the non-transitory, processor-readable storage medium comprises one or more programming instructions that, when executed, cause the processor to:
receive product design information for one or more products, wherein the product design information comprises customized information and template information;
generate a vector image, for each of the one or more products, based on the customized information;
generate slice data, for each of the one or more products, based on the vector image;
receive pre-sliced template data, for each of the one or more products, based on the template information;
nest the pre-sliced template data in a work area; and
nest the slice data in the work area to generate printing instructions.

12. The system of claim 11, further comprising an additive manufacturing device configured to generate the one or more products based on the printing instructions.

13. The system of claim 12, wherein the additive manufacturing device is a three-dimensional sand printer.

14. The system of claim 11, wherein the slice data and the pre-sliced template data correspond to portions of one or molds comprising a cavity configured to cast the one or more products.

15. The system of claim 11, wherein the customized information comprises one or more characters of text; and
wherein the one or more programming instructions that cause the processor to generate the slice data, for each of the one or more products, based on the vector image further cause the processor to simulate a draft on each of the one or more characters of text.

16. The system of claim 11, wherein the printing instructions are formatted in the Common Layer Interface.

17. The system of claim 11, wherein the one or more programming instructions that cause the processor to nest the slice data in the work area further cause the processor to perform affine transformations on one or more paths in the slice data.

18. The system of claim 11, wherein the one or more programming instructions that cause the processor to receive the pre-sliced template data, for each of the one or more products, based on the template information, further cause the processor to:
generate a three-dimensional model of a template;
slice the three-dimensional model of the template into the pre-sliced template data; and
store the pre-sliced template data in the non-transitory storage medium.

19. The system of claim 11, wherein the one or more programming instructions further cause the processor to:
optimize a utilization of the work area based on a combination of the slice data, the pre-sliced template data, and pre-sliced standard component data; and
nest the pre-sliced standard component data in the work area.

20. A non-transitory computer-readable medium storing a set of executable instructions comprising:
receiving product design information for one or more products, wherein the product design information comprises customized information and template information;
generating a vector image, for each of the one or more products, based on the customized information;
generating slice data, for each of the one or more products, based on the vector image;
receiving pre-sliced template data, for each of the one or more products, based on the template information;
nesting the pre-sliced template data in a work area; and
nesting the slice data in the work area to generate printing instructions.
